(19) United States
(12) Patent Application Publication
(10) Pub. No.: US 2003/0168636 A1
(43) Pub. Date: Sep. 11, 2003

(54) Oxide based phosphors

(76) Inventors: Peter James Dobson, Oxford (GB); Gareth Wakefield, Oxford (GB)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/296,125

(22) PCT Filed: May 22, 2001
(86) PCT No.: PCT/GB01/02288

(30) Foreign Application Priority Data
May 22, 2000 (GB) 0012377.8

(51) Int. Cl. C09K 11/08

(52) U.S. Cl. 252/301.4 R; 252/301.5; 252/301.6 R; 252/301.4 F; 252/301.6 F

(57) ABSTRACT

A process is disclosed for preparing phosphor particles of a doped host oxide which comprises: preparing an aqueous solution of salts of the host ion and of the dopant ion which is a rare earth, thorium, titanium, silicon, bismuth, copper, silver, tungsten or chromium and a water soluble compound, which decomposes under the reaction conditions to convert said salts into hydroxycarbonate, heating the solution so as to cause said compound to decompose, recovering the resulting precipitate and calcining it at a temperature of at least 500° C.

The present invention relates to oxide-based phosphors. Phosphors activated, in particular, by rare earths are known to possess excellent light output and colour rendering properties and have been utilized successfully in many display technologies. One particularly successful material, europium activated yttrium oxide (Y₂O₃:Eu³⁺) has shown particular promise in the field of field emission display; yttrium oxide acts as a host for the Eu³⁺or dopant ion.

The successful introduction of field emitting displays is dependent upon the availability of low voltage phosphors. As the phosphor exciting electrons have a comparatively low energy (less than 2 kV) as compared to conventional phosphors and one must avoid the use of sulphur to reduce contamination, new types of material have to be used. In particular, it is desirable to be able to make phosphor particles without a surface dead layer which occurs when fine particles are prepared using a conventional grinding technique. This dead layer is an important source of non-radiative luminescence routes for low energy electrons.

In our PCT/GB99/04299, the disclosure of which is incorporated by reference, we describe a process for preparing phosphor particles of a host oxide doped with a rare earth or manganese without the need for a grinding technique which comprises:

preparing an aqueous solution of salts of the host ion and of the dopant ion and a water soluble compound which decomposes under the reaction conditions to convert said salts into hydroxycarbonate,

heating the solution so as to cause said compound to decompose,

recovering the resulting precipitate and calcining it at a temperature of at least 500° C. The water-soluble compound which decomposes under the reaction condition is typically urea,-which is preferred, or a weak carboxylic acid such as oxalic acid or tartaric acid. The urea and other water soluble compounds slowly introduce OH− ligands into the solution until the solubility limit has been reached. When the urea decomposes it releases carbonate and hydroxide ions which control the precipitation. If this is done uniformly then particles form simultaneously at all points and growth occurs within a narrow size distribution.

We have now found, according to the present invention, that phosphors can be obtained in a similar manner where the dopant ion is not a rare earth or manganese and is, in particular, thorium, titanium, silicon, bismuth, copper, silver, tungsten or chromium.

Accordingly the present invention provides a process for preparing phosphor particles of a host oxide which has been doped which comprises:

preparing an aqueous solution of salts of the host ion and of the dopant ion which is thorium, titanium, silicon, bismuth, copper, silver, tungsten or chromium, and a water soluble compound which decomposes under the reaction conditions to convert said salts into hydroxycarbonate,

heating the solution so as to cause said compound to decompose,

recovering the resulting precipitate and

calcining it at a temperature of at least 500° C. with the proviso that the oxide is not a ternary oxide when the dopant is titanium or chromium.

The phosphors are typically binary oxides of the form Z_{z}O_{y}:RE where Z is a metal or metalloid of valency a such that 2y=a.z and RE is the dopant ion, or ternary oxides of the form ZₚX_{q} oxide:RE where Z is a metal or metalloid, X is a metal, metalloid or non-metal and RE is the dopant ion and p and q denote the atomic proportion of Z and X respectively. The binary oxides can be mixed oxides i.e. include mixed phases of the host compounds as in (Z¹ᵣZ²ₛ)_{z}O_{y}:RE where Z¹ and Z² are two different metals or metalloids and r+s total 1, e.g. (Y_{0.7}Gd_{0.3})₂O₃:EU³⁺.

In general the additional dopants for the binary oxides are chromium, copper and bismuth since it is likely that the other dopants will not give rise to a phosphor with the host oxide. The use of mixed binary oxides is novel and forms another aspect of the present invention.

The nature of the salts of the host and dopant ions is not particularly critical provided that they are water soluble. Typically, the salts are chlorides, but, for instance, a perchlorate can also be used.

In our PCT/GB99/04300, the disclosure of which is incorporated by reference, we describe ternary oxide phosphors having the formula:

Z_{z}XₓO_{y}: RE

where Z is a metal of valency b, such as yttrium, gadolinium, gallium and tantalum, X is a metal or metalloid of valency a, such as aluminium, silicon and zinc, such that 2y=b.z+a.x, and RE is a dopant ion of terbium, europium, cerium, thulium, samarium, holmium, erbium, dysprosium, praseodymium or manganese. We have now found that RE can represent any other rare earth.

In our PCT/GB99/04299 we list a variety of host ions, namely yttrium, gadolinium, gallium, lanthanum, lutetium, tantalum and aluminium. Additional host ions, Z (or Z¹ or Z² for the mixed binaries) which can be mentioned include-tin, indium, niobium, molybdenum, tantalum, tungsten and zinc, which are preferred for the binary oxides while additional ions for the ternary oxides include zinc, barium, calcium, cadmium, magnesium, strontium, zirconium, scandium, lanthanum, hafnium, titanium, vanadium, niobium, chromium, molybdenum, tungsten, beryllium, bismuth, indium, lutetium, lithium and lead.

Additional elements for X include gadolinium, tungsten, germanium, boron, vanadium, titanium, niobium, tantalum, molybdenum, chromium, zirconium, hafnium, manganese, phosphorus, copper, tin, lead and cerium.

Of course all the rare earth elements specifically mentioned in our PCT/GB99/04299 can be used, namely europium, terbium, cerium, thulium, dysprosium, erbium, neodymium, samarium, praseodymium and holmium.

The reaction is carried out at elevated temperature so as to decompose the water soluble compound. For urea, the lower temperature limit is about 70° C.; the upper limit of reaction is generally 100° C.

Doping with the “rare earth” metal salt can be carried out by adding the required amount of the dopant ion, typically from 0.1 to 30%, generally from 1 to 10%, for example about 5% (molar).

The reaction mixture can readily be obtained by mixing appropriate amounts of aqueous solutions of the salts and adding the decomposable compound.

It has been found that rather than start the process by dissolving salts of the desired elements there are advantages to be obtained by preparing the salts in situ by converting the corresponding oxides to these salts. Apart from the fact that oxides are generally significantly cheaper than corresponding chlorides or nitrates, it has also been found that cathodoluminescence of the resulting particles can be superior. Where, though, the oxide is very reactive, e.g. bismuth oxide, it is necessary to start with the salt.

It has been found that better results can generally be obtained by keeping the reaction vessel sealed. This has the effect of narrowing the size distribution of the resulting precipitate.

An important feature of the process is that decomposition takes place slowly so that the compounds are not obtained substantially instantaneously as in the usual precipitation techniques. Typically for urea, the reaction is carried out at, say, 90° C. for one to four hours, for example about 2 hours. After this time precipitation of a mixed amorphous/nanocrystalline phase is generally complete. This amorphous stage should then be washed and dried before being calcined. Decomposition of urea starts at about 80° C. It is the temperature which largely controls the rate of decomposition.

Although the particles obtained initially following the addition of the decomposable compound are monocrystalline they have a tendency to form composites or agglomerates consisting of two or more such crystals during precipitation and subsequent washing.

Calcination typically takes place in a conventional furnace in air but steam or an inert or a reducing atmosphere such as nitrogen or a mixture of hydrogen and nitrogen can also be employed. It is also possible to use, for example, a rapid thermal annealer or a microwave oven. The effect of using such an atmosphere is to reduce any tendency the rare earth element may have to change from a 3+ ion to a 4+ ion. This is particularly prone in the case of terbium and cerium as well as Mn²⁺. The use of hydrogen may also enhance the conductivity of the resulting crystals.

Calcination generally requires a temperature of at least 500° C., typically 600° C. to 900° C., for example about 650° C. However, by increasing the calcination temperature the crystallite size increases and this can lead to enhanced and this can lead to enhanced luminescence. In general, temperatures of at least 1000° C. are needed for grain growth to become significant. In general the temperature required is at least from one third to half the bulk melting point of the oxide (the Tamman temperature) which is typically of the order of 2500° C. Thus desirably the calcination temperature is at least 1050° C., a temperature of 1150° C. being typical.

Time also plays a part and, in general, at higher temperatures a shorter time can be used. In general the calcination is carried out at a temperature and time sufficient to produce a crystallite size of at least 35 nm, generally at least 50 nm.

The time of calcination is generally from 30 minutes to 10 hours and typically from 1 hour to 5 hours, for example about 3 hours. A typical calcination treatment involves a temperature of at least 1050° C., e.g. 1150° C. for 3 hours while at lower temperatures a time from 3 to 6 hours is typical. In general, temperatures above 1300 to 1400° C. are not needed. In order to augment crystallite size it is possible to incorporate flux agents which act as grain boundary promoters such as titania, bismuth oxides, silica, lithium fluoride and lithium oxide.

While, in the past, using lower temperatures of calcination, crystallite sizes of the order of 20 nm were obtained it has been found, according to the present invention, that crystallite sizes of at least 50 nm are regularly obtainable. Indeed crystallite sizes as much as 200 nm can be obtained without difficulty. As the temperature of calcination increases the particles have a tendency to break up into single or monocrystalline particles. If the calcination takes place for too long there is a danger of significant crystal sintering. Obviously the particle size desired will vary depending on the particular application of the phosphors. In particular the acceleration voltage affects the size needed such that at 300 volts a crystallite size of the order of 50 nm is generally suitable.

The urea or other decomposable compound should be present in an amount sufficient to convert the salts into hydroxycarbonate. This means that the mole ratio of e.g. urea to salt should generally be at least 1:1. Increasing the amount of urea tends to increase the rate at which hydroxycarbonate is formed. If it is formed too quickly the size of the resultant particles tends to increase. Better results are usually obtained if the rate of formation of the particles is relatively slow. Indeed in this way substantially monocrystalline particles can be obtained. In general the mole ratio of urea or other decomposable compound to salt is from 1:1 to 10:1, typically 2:1 to 5:1, for example about 3:1; although higher ratios, for example 15:1, may be desirable if the initial solution is acidic and sometimes they improve yield. Typically the pH will be from about 0.5 to 2.0 although somewhat different values may be used if the salt is formed in situ. In general, the effect of the mole ratio on crystallite size is insignificant when the calcination temperature exceeds 1000° C.

The present invention also provides substantially monocrystalline particles, as well as particles in the form of composites such as crystallites, of the binary oxides having the formula:

Z_{z}O_{y}: RE, as well as particles of the mixed binary oxides and of the ternary oxides, obtained by the process of the present invention.

By “substantially monocrystalline” is meant that particles form a single crystal although the presence of some smaller crystals dispersed in the matrix of the single crystal is not excluded. The “composites” are particles comprising two or more such crystals.

The particles obtained by the process of the present invention generally have a particle size not exceeding 1 micron and typically not exceeding 300 nm, for example from 50 to 150 nm and, as indicated above, they are preferably monocrystalline.

The particles of the present invention are suitable for use in FED type displays. For this purpose the particles can be embedded in a suitable plastics material by a variety of methods including dip coating, spin coating and meniscus coating or by using an air gun spray. Alternatively the particles can be,applied to the plastics material to provide a coherent screen by a standard electrophoretic method. Accordingly, the present invention also provides a plastics material which incorporates particles of the present invention.

Suitable polymers which can be employed include polyacrylic acid, polystyrene and polymethyl methacrylate. Such plastics materials can be used for photoluminescence applications and also in electroluminescence applications where an AC current is to be employed. If a DC current is employed then conducting polymers such as polyvinylcarbazole, polyphenylenevinylidene and polymethylphenylsilane can be employed. Poly 2-(4-biphenylyl)-5-(4-tertiarybutyl phenyl)-1,3,4-oxidiazole (butyl-PBD) can also be used. Desirably, the polymer should be compatible with the solvent employed, typically methanol, in coating the plastics material with the particles.

Typically, the particles will be applied to a thin layer of the plastics material, typically having a thickness from 0.5 to 15 microns.

The maximum concentration of particles is generally about 35% by weight with 65% by weight of polymer. There is a tendency for the polymer to crack if the concentration exceeds this value. A typical minimum concentration is about 2% by weight (98% by weight polymer). If the concentration is reduced below this value then “holes” tend to form in the plastics material.

The following Examples further illustrate the present invention.

### EXAMPLE 1

Production of Zn₂SiO₄:Mn

1.1 Set up a 5 litre beaker containing about 1.5 litres of water and a magnetic follower on a stirrer hotplate. Add 100 ml. of concentrated hydrochloric acid, (measuring cylinder), while stirring.

Weigh 52.9 grams of zinc oxide and disperse in the water, stirring rapidly to avoid clumping.

1.2 Insert a pH probe into the suspension and heat to dissolve the oxide. Add more HCl as necessary keeping the pH above 1.

1.3 Finally, add 3.53 grams of manganese perchlorate tetrahydrate to the zinc solution.

1.4 Sit a 2 litre beaker containing about 1 litre of de-ionised water within a 2 litre crystallizing dish. Pack the space between the dish and the beaker with crushed ice. Fix up a Greaves mixer so that the stirrer is slightly above the bottom of the beaker. Stir the water gently and allow the temperature of the water to fall to about 5° C. before the starting the next stage of the process.

1.5 Use a 20 ml. plastic syringe fitted with a steel hypodermic needle, successively, to remove 39 ml. of silicon tetrachloride from the SureSeal bottle.

1.6 Increase the speed of the mixer to a point where the water is highly agitated but not splashing out of the beaker. Add the silicon tetrachloride in a steady stream to the water. The aim is to make a silica sol with no gel lumps present.

1.7 Set up a 5 litre round-bottomed reaction flask, fitted with a lid, in a heating mantle. Fit a breather tube to one outlet and a B34 powder funnel to another. Any other ports may be blocked off. Add 600 grams of urea through the funnel followed by about 1.5 litres of water. Warm to dissolve the urea.

1.8 Add the silica suspension to the zinc solution and, after mixing, add the combined solutions to the contents of the round-bottomed flask. Heat the mixed solutions to 95° C., or greater to decompose the urea and precipitate the oxide. This will begin to take place when the pH reaches about 5.3. Maintain the temperature for another 2 hours and allow to cool naturally.

1.9 Allow the precipitate to settle and rack off the supernatant liquid. Add about 2 litres of clean water to the flask, swirl to mix thoroughly and allow the precipitate to settle. Rack off the supernatant liquid as before. Repeat the washing process 6 times in total. Collect the washings and store them in the plastic water butt reserved for the purpose.

1.10 Transfer the oxide slurry to a glass evaporation dish and heat gently on a hotplate to remove most of the water. Transfer the dish to an air circulation oven at 150° C. to finish the drying process.

1.11 The material is fired in a muffle furnace at 1150° C. for 3 hours to crystallize the precursor into 70 nm Zn_{z}SᵢO₄:Mn crystals.

### EXAMPLE 2

Production of YNbO₄:Bi

2.1 Set up a 5 litre beaker containing about 2 litres of water and a magnetic follower on a stirrer hotplate. Add 50 ml of concentrated hydrochloric acid, (measuring cylinder), while stirring.

2.2 Weigh 28.5 grams of yttrium oxide and disperse in the water, stirring rapidly to avoid clumping.

2.3 Insert a pH probe into-the suspension and heat to dissolve the oxide. Add more HCl as necessary to completely dissolve the oxide whilst keeping the pH above 1.

2.4 Add to the yttrium solution 68 grams of niobium pentachloride, slowly and cautiously, using a spoon spatula, allowing the vigorous reaction to die down each time before adding more.

2.5 Add 0.78 grams of bismuth chloride to about 1 ml. concentrated hydrochloric acid in a 50 ml. beaker and swirl to dissolve. Dilute this solution as much as possible by adding water slowly while avoiding the formation of white bismuth oxychloride. Add this solution to the yttrium solution while stirring rapidly.

2.6 Set up a 5 litre round-bottomed flask, fitted with a lid, in a heating mantle. Fit a breather tube to one outlet and a B34 powder funnel to another. Any other ports may be blocked off. Add 600 grams of urea through the funnel followed by about 2 litres of water. Warm to dissolve the urea.

2.7 Add the combined yttria solution to the urea solution in the round-bottomed flask. Replace the funnel with a B34 stopper. Heat the mixed solutions to 95° C., or greater to decompose the urea and precipitate the oxide. This will begin to take place when the pH reaches about 5.3. Maintain the temperature for another 2 hours and allow to cool naturally, this is best done overnight.

2.8 Allow the precipitate to settle and rack off the supernatant liquid into a beaker using an aquarium siphon. Add about 2 litres of clean water to the flask, swirl to mix thoroughly and allow the precipitate to settle. Rack off the supernatant liquid as before. Repeat the washing process.

2.9 Transfer the oxide slurry to a glass evaporation dish and place in an air circulation oven at 150° C. until a dried cake is obtained.

2.10 The precursor is then fired in a muffle furnace in air at 1150° C. to crystallise the product into 70-100 nm beta fergusonite YNbO₄:Bi.

1. A process for preparing phosphor particles of a doped host oxide which comprises:
preparing an aqueous solution of salts of the host ion and of the dopant ion which is thorium, titanium, silicon, bismuth, copper, silver, tungsten or chromium and a water soluble compound, which decomposes under the reaction conditions to convert said salts into hydroxycarbonate,
heating the solution so as to cause said compound to decompose,
recovering the resulting precipitate and
calcining it at a temperature of at least 500° C., with the proviso that the oxide is not a ternary oxide when the dopant is titanium or chromium.

2. A process for preparing phosphor particles of the formula (Zᵣ¹Zₛ²)_{z}O_{y}:RE where Z¹ and Z² are two different elements of the host oxide and r+s=1, 2y=a.z where a is the overall valence of Zᵣ¹Zₛ² and RE represents a dopant ion of a rare earth, manganese, bismuth, copper or chromium which comprises:
preparing an aqueous solution of salts of the host ion and of the dopant ion and a water soluble compound which decomposes under the reaction conditions to convert said salts into hydroxycarbonate,
heating the solution so as to cause said compound to decompose;
recovering the resulting precipitate and
calcining it at a temperature of at least 500° C.

3. A process for preparing phosphor particles of the formula Z_{z}O_{y}:RE where RE is a rare earth, manganese, bismuth, copper or chromium and Z is tin, indium, niobium, molybdenum, tantalum, tungsten or zinc which comprises
preparing an aqueous solution of salts of the host ion and of the dopant ion and a water soluble compound which decomposes under the reaction conditions to convert said salts into hydroxycarbonate,
heating the solution so as to cause said compound to decompose;
recovering the resulting precipitate and
calcining it at a temperature of at least 500° C.

4. A process for preparing phosphor particles of the formula:
ZₚX_{q} oxide:RE where RE is a dopant ion of a rare earth, manganese, thorium, titanium, silicon, bismuth, copper, silver, tungsten or chromium, X is a metal or metalloid, Z is zinc, barium, calcium, cadmium, magnesium, strontium, zirconium, scandium, lanthanum, hafnium, titanium, vanadium, niobium, chromium, molybdenum, tungsten, beryllium, bismuth, indium, lutetium, lithium or lead and p and q denote the atomic proportion of Z and X respectively, which comprises:
preparing an aqueous solution of salts of the host ion and of the dopant ion and a water soluble compound which decomposes under the reaction conditions to convert said salts into hydroxycarbonate,
heating the solution so as to cause said compound to decompose;
recovering the resulting precipitate and calcining it at a temperature of at least 500° C.

5. A process for preparing phosphor particles of the formula:
ZₚX_{q} oxide:RE where RE is a dopant ion of a rare earth, manganese, thorium, titanium, silicon, bismuth, copper, silver, tungsten or chromium, Z is a metal or metalloid, X is gallium, tungsten, germanium, boron, vanadium, titanium, niobium, tantalum, molybdenum, chromium, zirconium, hafnium, manganese, phosphorus, copper, tin, lead or cerium and p and q denote the atomic proportion of Z and X respectively,- which comprises:
preparing an aqueous solution of salts of the host ion and of the dopant ion and a water soluble compound which decomposes under the reaction conditions to convert said salts into hydroxycarbonate,
heating the solution so as to cause said compound to decompose;
recovering the resulting precipitate and
calcining it at a temperature of at least 500° C.

6. A process for preparing phosphor particles of the formula: ZₚX_{q} oxide: RE where RE is a dopant ion of a rare earth which is not terbium, europium, cerium, thulium, samarium, holmium, erbium, dysprosium or praseodymium, X is a metal, metalloid or non-metal, Z is a metal or metalloid and p and q denote the atomic proportion of Z and X respectively, which comprises:
preparing an aqueous solution of salts of the host ion and of the dopant ion and a water soluble compound which decomposes under the reaction conditions to convert said salts into hydroxycarbonate,
heating the solution so as to cause said compound to decompose;
recovering the resulting precipitate and
calcining it at a temperature of at least 500° C.

7. A process according to any one of the preceding claims in which at least one of the salts is a chloride.

8. A process according to any one of the preceding claims in which the salts are formed in situ from the corresponding oxides and the corresponding acid.

9. A process according to any one of the preceding claims in which the said water soluble compound is urea or oxalic acid.

10. A process according to claim 9 in which the solution is heated to a temperature of 70 to 100° C.

11. A process according to any one of the preceding claims in which the dopant is added in an amount to provide a concentration of 1 to 10% in the particles.

12. A process according to any one of the preceding claims in which the heating step is carried out in a sealed vessel.

13. A process according to any one of the preceding claims in which the calcination takes place in air or a reducing atmosphere.

14. A process according to claim 13 in which the calcination takes place at a temperature of at least ⅓ the Tamman temperature of the host oxide.

15. A process according to claim 14 in which the calcination takes place at a temperature of at least 1050° C. for 1 to 5 hours.

16. A process according to any one of the preceding claims in which the particles are substantially monocrystalline.

17. A process according to any one of the preceding claims in which the particles have a size from 50 to 150 nm.

18. A process according to claim 1 substantially as hereinbefore described.

19. Phosphor particles whenever prepared by a process as claimed in any one of the preceding claims.

20. Substantially monocrystalline particles, and particles in the form of composites of such crystals, having the formula:
Z=hd zO_{y}:RE
as defined in claim 3 or 4.

21. Particles of the formula: (Zᵣ¹Zₛ²)_{z}O_{y}:RE as defined in claim 2.

22. Particles of the formula: ZₚX_{q} oxide:RE as defined in claim 5 or 6.

23. Particles according to any one of claims 20 to 22 having one or more of the features of claims 11 and 17.

24. A plastics material which comprises particles as claimed in any one of claims 19 to 23.

25. A material according to claim 24 which is 0.5 to 15 microns thick.

26. A material according to claim 24 or 25 which contains 2 to 35% by weight of the particles based on the weight of the material.

27. A material according to any one of claims 24 to 26 which is made of an electrically conducting polymer.

28. A material according to any one of claims 24 to 27 which is made of polyacrylic acid, polymethylmethacrylate or polystyrene.
